(19) United States
(12) Patent Application Publication
(10) Pub. No.: US 2018/0189698 A1
(43) Pub. Date: Jul. 5, 2018

(54) Contextual Analysis of Business Intelligence Reports

(71) Applicant: International Business Machines Corporation, Armonk, NY (US)

(72) Inventors: Munish Goyal, Yorktown Heights, NY (US); Wing L. Leung, Austin, TX (US); Sarbajit K. Rakshit, Kolkata (IN); Kimberly G. Starks, Nashville, TN (US)

(21) Appl. No.: 15/399,266

(22) Filed: Jan. 5, 2017

(51) Int. Cl. G06Q 10/06; G06F 17/30

(52) U.S. Cl. CPC G06Q 10/0637; G06F 17/30876; G06F 17/30696

(57) ABSTRACT

Adjusting a business intelligence report is provided. An identification of an input data source corresponding to content of the business intelligence report is received from a client device via a network. An unstructured text stream is extracted from the input data source. A set of parameter values that are contextually-related to the content of the business intelligence report is identified. The business intelligence report is adjusted using the set of parameter values that are contextually-related to the content of the business intelligence report.

### BACKGROUND

### 1. Field

The disclosure relates generally to business intelligence reports and more specifically to adjusting a business intelligence report using information contextually-related to content of the business intelligence report automatically extracted from one or more input data sources.

### 2. Description of the Related Art

Business intelligence (BI) is a technology-driven process for analyzing data and presenting actionable information to assist users in making informed decisions. Business intelligence utilizes a variety of techniques to collect the data, analyze the data, and create reports and data visualizations to make the analytical results of the data available to the users. The business intelligence reports include business metrics and key performance indicators of interest to the users.

Existing business intelligence systems allow the users to perform analysis of the business intelligence reports. For example, existing business intelligence systems allow the users to perform a “what-if” analysis, “ad-hoc” analysis, and the like on business intelligence reports. A what-if analysis is the process of changing values of parameters and then showing how those parameter changes will affect outcomes in a business intelligence report. For example, during a budget calculation a user may want a what-if analysis to be performed on a business intelligence report. An ad-hoc analysis is a process that allows a user to select a specific report object to modify a business intelligence report. In existing business intelligence systems, a user changes the values manually in one or more places in a report and then re-runs the report so that the impacted values and results may be reviewed by the user.

### SUMMARY

According to one illustrative embodiment, a computer-implemented method for adjusting a business intelligence report is provided. A computer receives an identification of an input data source corresponding to content of the business intelligence report from a client device via a network. The computer extracts an unstructured text stream from the input data source. The computer identifies a set of parameter values that are contextually-related to the content of the business intelligence report. The computer adjusts the business intelligence report using the set of parameter values that are contextually-related to the content of the business intelligence report. According to other illustrative embodiments, a computer system and computer program product for adjusting a business intelligence report are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a business intelligence report management system in accordance with an illustrative embodiment;

FIG. 4 is an example of a business intelligence report display in accordance with an illustrative embodiment;

FIGS. 5A-5B are a flowchart illustrating a process for contextual analysis of a business intelligence report in accordance with an illustrative embodiment; and

FIG. 6 is a flowchart illustrating a process for adjusting a business intelligence report in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

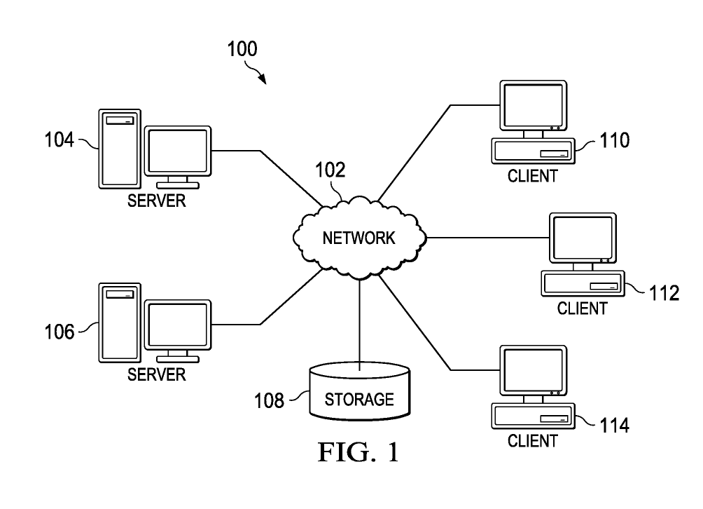

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide services for adjusting business intelligence reports using information contextually-related to content of the business intelligence reports automatically extracted from one or more input data sources. Also, it should be noted that server 104 and server 106 may each represent a plurality of different servers providing a plurality of different business intelligence report management services.

Client 110, client 112, and client 114 also connect to network 102. Clients 110, 112, and 114 are clients of server 104 and server 106. Further, server 104 and server 106 may provide information, such as software applications and programs to clients 110, 112, and 114.

In this example, clients 110, 112, and 114 are illustrated as desktop or personal computers with wire or wireless communication links to network 102. However, it should be noted that clients 110, 112, and 114 are meant as examples only. In other words, clients 110, 112, and 114 may include other types of data processing systems, such as, for example, laptop computers, handheld computers, smart phones, smart watches, personal digital assistants, and the like, with wire or wireless communication links to network 102. Users of clients 110, 112, and 114 may utilize clients 110, 112, and 114 to access the services provided by server 104 and server 106 of adjusting business intelligence reports using information contextually-related to content of the business intelligence reports automatically extracted from one or more input data sources. The users of clients 110, 112, and 114 may provide identification information, such as, for example, uniform resource locators (URLs), corresponding to the input data sources, such as, for example, web pages or web documents, and/or may input textual content as the input data sources.

Storage 108 is a network storage device capable of storing any type of data in a structured format or an unstructured format. In addition, storage 108 may represent a set of one or more network storage devices. Storage 108 may store, for example, names and identification numbers for a plurality of different client device users that utilize the business intelligence report management services of server 104 and server 106; profiles corresponding to the different client device users; a plurality of different business intelligence reports; business intelligence report rules corresponding to the different business intelligence reports; and the like. Further, storage 108 may store other data, such as authentication or credential data that may include user names, passwords, and biometric data associated with the client device users, for example.

In addition, it should be noted that network data processing system 100 may include any number of additional server devices, client devices, and other devices not shown. Program code located in network data processing system 100 may be stored on a computer readable storage medium and downloaded to a computer or data processing system for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), or any combination thereof. FIG. 1 is intended as an example, and not as an architectural limitation for the different illustrative embodiments.

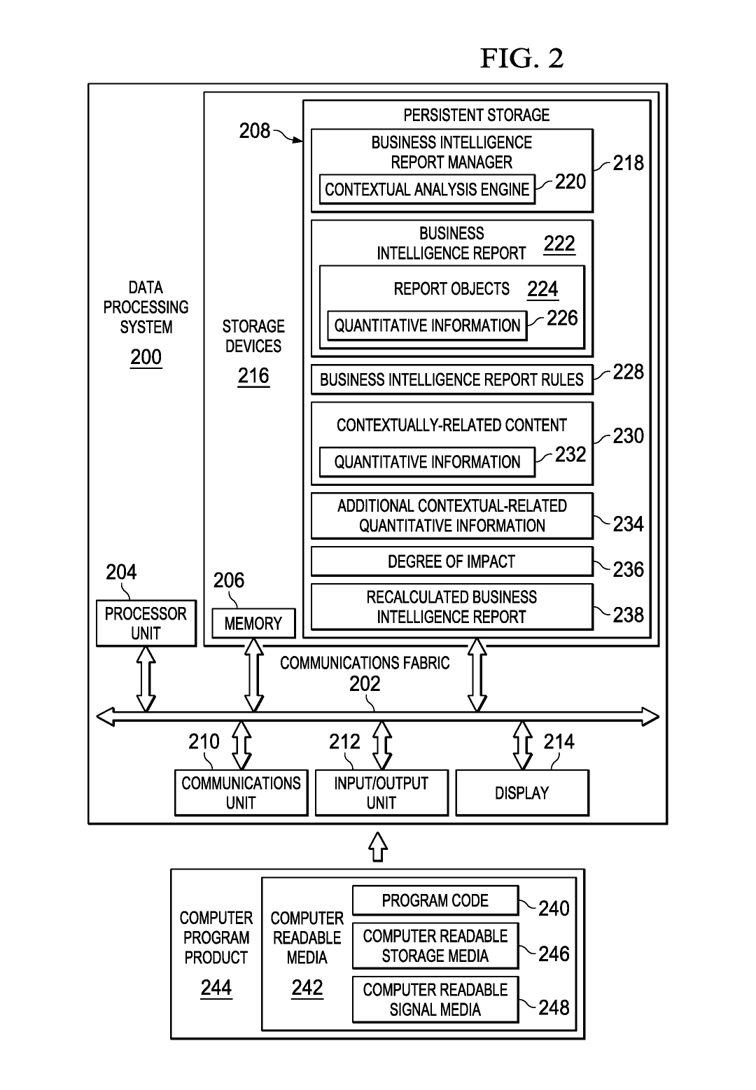

With reference now to FIG. 2, a diagram of a data processing system is depicted in accordance with an illustrative embodiment. Data processing system 200 is an example of a computer, such as server 104 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores business intelligence report manager 218. Business intelligence report manager 218 automatically adjusts business intelligence reports using information contextually-related to content of the business intelligence reports identified in and extracted from a set of one or more input data sources, such as, for example, documents, articles, and news stories located on the World Wide Web. Business intelligence report manager 218 locates and accesses these input data sources using identifiers, such as web addresses or uniform resource locators, which are provided by users of client devices, such as clients 110, 112, and 114 in FIG. 1.

It should be noted that even though business intelligence report manager 218 is illustrated as residing in persistent storage 208, in an alternative illustrative embodiment business intelligence report manager 218 may be a separate component of data processing system 200. For example, business intelligence report manager 218 may be a hardware component coupled to communication fabric 202 or a combination of hardware and software components. In another alternative illustrative embodiment, a first set of components of business intelligence report manager 218 may be located in data processing system 200 and a second set of components of business intelligence report manager 218 may be located in a client device.

In this example, business intelligence report manager 218 includes contextual analysis engine 220. Business intelligence report manager 218 utilizes contextual analysis engine 220 to identify and extract contextually-related content to a business intelligence report from one or more input data sources identified by a client device user associated with the business intelligence report. Contextual analysis engine 220 may utilize, for example, natural language processing (NLP) to identify and extract the contextually-related content. In addition, contextual analysis engine 220 applies the contextually-related content extracted from the input data sources to adjust or modify the business intelligence report.

For example, business intelligence report manager 218 receives an indication that business intelligence report 222 has been opened on a client device of a user associated with a corporation, company, or enterprise. Business intelligence report 222 may represent any type of business intelligence report corresponding to the corporation, company, or enterprise. After receiving the indication that business intelligence report 222 has been opened on the client device, business intelligence report manager 218 identifies report objects 224 in business intelligence report 222. Report objects 224 represent dimensions or attributes of business intelligence report 222, key performance indicators (KPIs) of the corporation, company, or enterprise corresponding to business intelligence report 222, parameters of business intelligence report 222, filters associated with business intelligence report 222, and the like. The filters associated with business intelligence report 222 limit the amount of information extracted from the input data sources that is to be used to adjust business intelligence report 222. For example, a filter may limit the information extracted from the input data sources to a particular period of time, such as a one year period, a quarter, a month, or any other period of time.

Report objects 224 also include quantitative information 226. Quantitative information 226 represents quantified metrics and their associated data. An example of quantitative information 226 may be that the economic growth of a particular company associated with business intelligence report 222 grew by 10% in the fourth quarter of last year.

Further, business intelligence report manager 218 retrieves business intelligence report rules 228, which correspond to business intelligence report 222. Business intelligence report manager 218 utilizes business intelligence report rules 228 to assist contextual analysis engine 220 to identify and extract contextually-related content, such as contextually-related content 230, from one or more input data sources. Contextually-related content 230 represents information that correlates to content within business intelligence report 222. Contextually-related content 230 includes quantitative information 232, which corresponds to quantitative information 226.

Business intelligence report rules 228 may include, for example, definitions and corresponding information for different terms within business intelligence report 222 so that contextual analysis engine 220 may determine how contextually-related content 230 is relevant to business intelligence report 222 and where contextually-related content 230 is relevant within business intelligence report 222. A developer of business intelligence report 222 may develop business intelligence report rules 228 when creating the format and design of business intelligence report 222. In addition, business intelligence report rules 228 may identify which key performance indicators to monitor and adjust within business intelligence report 222.

Furthermore, business intelligence report manager 218 searches one or more online data sources, such as, for example, websites, databases, data stores, or data warehouses, for additional contextually-related quantitative information 234. It should be noted that the online data sources are different and separate from the input data sources. Additional contextually-related quantitative information 234 is supplementary information that relates to and further defines and explains quantitative information 232 of contextually-related content 230. Business intelligence report manager 218 may utilize the natural language processing capabilities of contextual analysis engine 220 to identify and extract additional contextually-related quantitative information 234 from the online data sources.

Moreover, contextual analysis engine 220 also may utilize business intelligence report rules 228 to determine how and to what degree contextually-related content 230 and additional contextually-related quantitative information 234 impact business intelligence report 222. After determining how and to what degree contextually-related content 230 and additional contextually-related quantitative information 234 impact business intelligence report 222, contextual analysis engine 220 generates degree of impact 236 for business intelligence report 222. Then, business intelligence report manager 218 utilizes contextually-related content 230, additional contextually-related quantitative information 234, and degree of impact 236 to recalculate and adjust business intelligence report 222 to form recalculated business intelligence report 238. Business intelligence report manager 218 displays recalculated business intelligence report 238 on the client device of the user that opened business intelligence report 222.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (WiFi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keyboard, keypad, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 240 is located in a functional form on computer readable media 242 that is selectively removable and may be loaded onto or transferred to data processing system 200 for running by processor unit 204. Program code 240 and computer readable media 242 form computer program product 244. In one example, computer readable media 242 may be computer readable storage media 246 or computer readable signal media 248. Computer readable storage media 246 may include, for example, an optical or magnetic disc that is inserted or placed into a drive or other device that is part of persistent storage 208 for transfer onto a storage device, such as a hard drive, that is part of persistent storage 208. Computer readable storage media 246 also may take the form of a persistent storage, such as a hard drive, a thumb drive, or a flash memory that is connected to data processing system 200. In some instances, computer readable storage media 246 may not be removable from data processing system 200.

Alternatively, program code 240 may be transferred to data processing system 200 using computer readable signal media 248. Computer readable signal media 248 may be, for example, a propagated data signal containing program code 240. For example, computer readable signal media 248 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 240 may be downloaded over a network to persistent storage 208 from another device or data processing system through computer readable signal media 248 for use within data processing system 200. For instance, program code stored in a computer readable storage media in a data processing system may be downloaded over a network from the data processing system to data processing system 200. The data processing system providing program code 240 may be a server computer, a client computer, or some other device capable of storing and transmitting program code 240.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 246 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments utilize context to impact the results of business intelligence reports in real time based on current and past news reports and uniform resource locators for ingestion. For example, while reading an online news article on economic growth, a user may be interested to see how the user's business data will be impacted based on the content of the news article. Illustrative embodiments provide a system by which the user can receive contextual analysis of the news article and get impact results on the user's business data based on this news data in real time.

In addition, illustrative embodiments provide a method to expand the context while maintaining relevance to the business intelligence report being reviewed by the user. Illustrative embodiments access and analyze content of uniform resource locators, news reports, and/or textual data to adjust a business intelligence report based on the values present in the content of the uniform resource locators, news reports, and/or textual data and determine the impact the content from these information sources will have on the business intelligence report.

For example, while analyzing a business intelligence report, a user of a client device may provide identification of one or more input data sources, such as uniform resource locators or textual content, as additional input for the contextual analysis of the business intelligence report. Illustrative embodiments perform the contextual analysis of extracted relevant portions from the input data sources to identify contextually-related parameters values for “what-if” analysis and/or “ad-hoc” analysis of that particular business intelligence report. Further, illustrative embodiments override or replace the parameter values presently contained in the report with the contextually-related parameter values identified in the input data sources. Furthermore, at any time, the user can remove and add input data sources. Moreover, illustrative embodiments aggregate the content of the input data sources to find contextually-related parameter values to use for the contextual analysis of the business intelligence report. For example, the user may drag or drop one or more uniform resource locators and/or textual information on a display of the business intelligence report and in response illustrative embodiments perform contextual analysis of the content of the uniform resource locators and/or textual information as they relate to the business intelligence report.

Thus, illustrative embodiments may provide real time adjustments to business intelligence reports based on up-to-the-minute data available in streaming media sources. This real time adjustment of business intelligence reports puts the power in the hands of business intelligence report users, developers, and analysts. In addition, this adjustment to business intelligence reports allows companies to adapt to current changing dynamics occurring in real time within an industry.

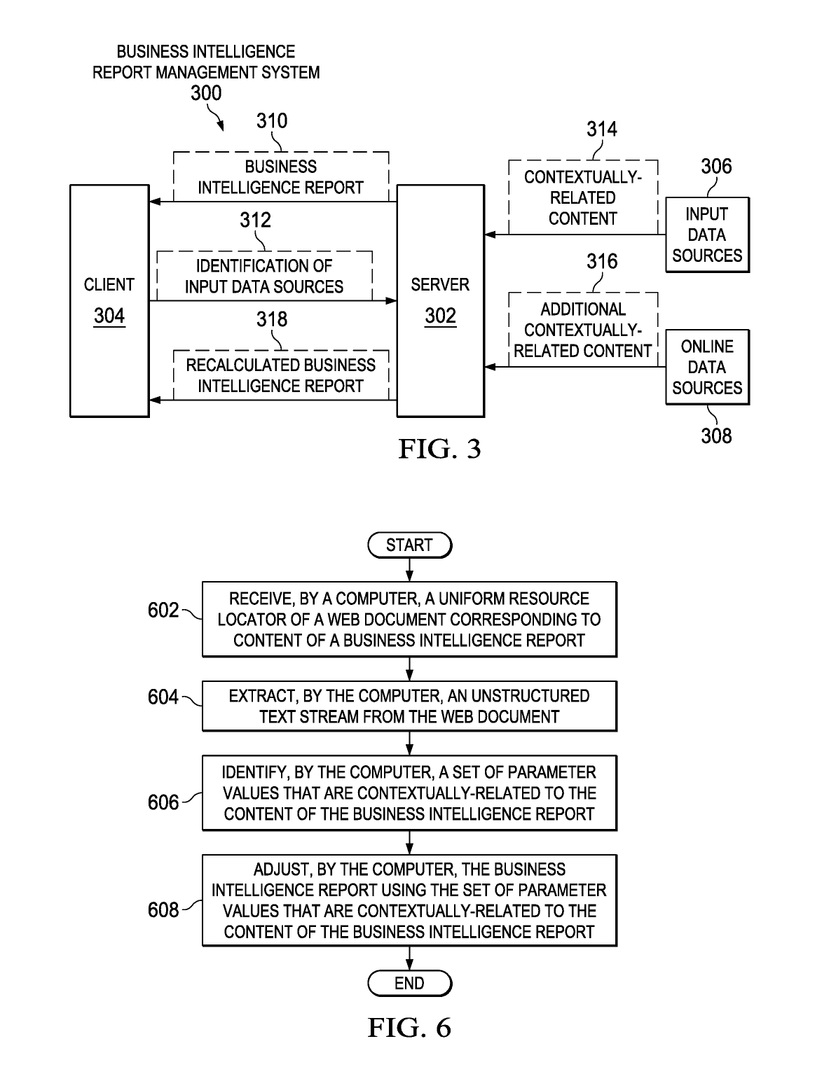

With reference now to FIG. 3, a diagram illustrating an example of a business intelligence report management system is depicted in accordance with an illustrative embodiment. Business intelligence report management system 300 is a system of software and hardware components for controlling the automatic adjustment of business intelligence reports using information contextually-related to content of the business intelligence reports extracted from one or more input data sources. Business intelligence report management system 300 may be implemented in a network of data processing systems, such as network data processing system 100 in FIG. 1.

In this example, business intelligence report management system 300 includes server 302, client 304, input data sources 306, and online data sources 308. However, it should be noted that business intelligence report management system 300 is only meant as an example and not as a limitation on illustrative embodiments. In other words, business intelligence report management system 300 may include any number of servers, clients, and data sources.

Server 302 may be, for example, server 104 in FIG. 1 or data processing system 200 in FIG. 2. A user of client 304 may request business intelligence report 310 from server 302. After business intelligence report 310 opens on client 304, a business intelligence report manager, such as business intelligence report manager 218 in FIG. 2, knows the report objects, such as report objects 224 in FIG. 2, contained within the selected business intelligence report. The report objects may be, for example, dimensions/attributes, key performance indicators, parameters, filters, and the like corresponding to business intelligence report 310.

In addition, the user of client 304 sends identification of input data sources 312 to server 302. The identification of input data sources 312 may be, for example, a set of web addresses or uniform resource locators corresponding to content that is related and relevant to business intelligence report 310. For example, the user may drag and drop one or more uniform resource locators on business intelligence report 310, which is open on a display of client 304. Server 302 utilizes identification of input data sources 312 to access input data sources 306 and extract contextually-related content 314 from input data sources 306. Contextually-related content 314 may be, for example, contextually-related content 230 in FIG. 2. The business intelligence report manager of server 302 does not consider, for example, ad blocks, headers, footers, and the like in content of input data sources 306.

Further, the business intelligence report manager of server 302 aggregates contextually-related content 314 from the various data sources in input data sources 306 and identifies key relevant information within the aggregated content. For example, the business intelligence report manager may identify information, such as: 1) 19 countries in Europe use the Euro; 2) these 19 counties make an annual rate of expansion of 1.5% for the first quarter of this year; 3) the U.S. economy grew by 0.7% in the fourth quarter of this year and 2.4% for the entire year; 4) consumer spending has been the main economic growth driver; and 5) Spain powered ahead with 0.8% economic growth in the last quarter of this year; as the key relevant information that corresponds to business intelligence report 310 within the aggregated content from input data sources 306. Further, the business intelligence report manager of server 302 searches a set of rules, which correspond to business intelligence report 310, to determine how the key relevant information extracted from input data sources 306 is related to business intelligence report 310. The set of rules may be, for example, business intelligence report rules 228 in FIG. 2. The business intelligence report manager of server 302 may update and add rules to the set as required, but also may source these rules from external data corpuses to build upon the context necessary to identify and extract additional information from other data sources.

Moreover, the business intelligence report manager of server 302 also may search the Internet and other known, reliable data sources, such as online data sources 308, to find additional contextually-related content 316, which is relevant to business intelligence report 310. Additional contextually-related content 316 may be, for example, what are the names of the 19 countries in Europe that use the Euro, what is the meaning of annual rate of expansion, and the like. For example, additional contextually-related content 316 may indicate that a 1% annual rate of expansion creates a 5% impact on key performance indicators 1, 2, and 3 and a 2% annual rate of expansion creates a 7% impact on key performance indicators 1, 2, and 3.

Based on the set of rules, the business intelligence report manager of server 302 extrapolates and/or interpolates the degree of impact on the various key performance indicators contained within business intelligence report 310. Then, the business intelligence report manager of server 302 identifies the current values of the impacted key performance indicators within business intelligence report 310 and identifies the new values for the impacted key performance indicators based on the analysis of contextually-related content 314 and additional contextually-related content 316. Afterward, the business intelligence report manager of server 302 replaces the current values of the impacted key performance indicators within business intelligence report 310 with the new values. Subsequently, the business intelligence report manager of server 302 recalculates business intelligence report 310 using the new values for the impacted key performance indicators to form recalculated business intelligence report 318. In addition, the business intelligence report manager of server 302 displays recalculated business intelligence report 318 on client 304 for the user to review and implement one or more action steps, if necessary, based on the changes in the recalculated report.

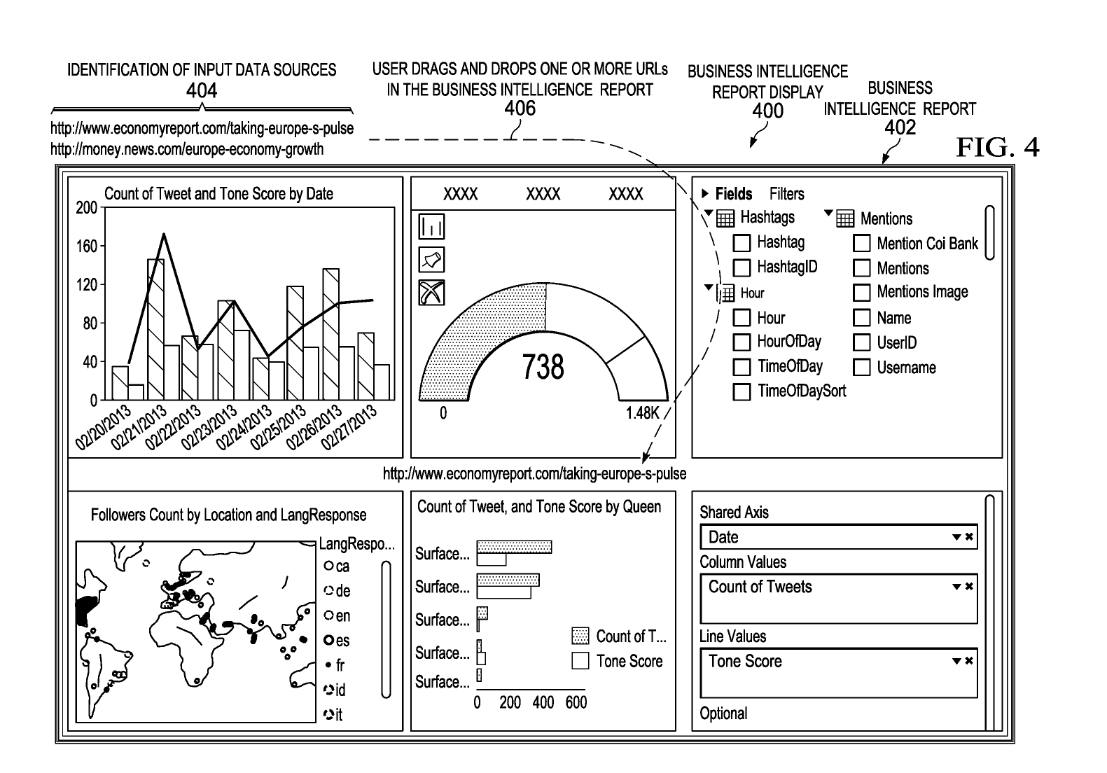

With reference now to FIG. 4, an example of a business intelligence report display is depicted in accordance with an illustrative embodiment. Business intelligence report display 400 displays business intelligence report 402 on a display of a client device, such as client 304 in FIG. 3. Business intelligence report 402 may represent any type of business intelligence report.

In this example, a user of the client device provides identification of input data sources 404. Also in this example, identification of input data sources 404 includes two uniform resource locators as contextual data input for analysis. The two uniform resource locators are http://www.economyreport.com/ taking-europe-s-pulse and http://money.news.com/europe-economy-growth. At 406, the user drags and drops a uniform resource locator (i.e., http://www.economyreport.com/ taking-europe-s-pulse) in business intelligence report 402. However, it should be noted that the user also may input textual content as additional information for analysis for business intelligence report 402.

After the user applies the input data sources to business intelligence report 402, a business intelligence report manager, such as business intelligence report manager 218 in FIG. 2, extracts relevant information from the input data sources and performs contextual analysis of the extracted information to identify various parameters and their respective values corresponding to business intelligence report 402. It should be noted that the business intelligence report manager removes, for example, any advertisements and reference links, from the input data sources to only consider relevant content. Also, the business intelligence report manager may consider various predefined rules stored in the server, such as server 302 in FIG. 3. Based on the contextual analysis and the predefined rules, the business intelligence report manager overrides the existing values in business intelligence report 402 with the identified relevant parameter values within the input data sources and recalculates business intelligence report 402 based on the given context.

As an example, a user opens on a client device a business intelligence report for all car sales across the world in a particular year. Then, the user drags and drops a uniform resource locator of a news article, such as http://www.network.com/news/business, on the currently open business intelligence report. The news article indicates that car sales for that particular year are up in counties, such as the United States, Germany, France, Switzerland, Italy, United Kingdom, and Australia by a sales value of 100,000, 30,000, 50,000, 58,000, 87,000, 43,000, and 94,000, respectively.

The business intelligence report manager performs a what-if analysis and an ad-hoc analysis on the currently open business intelligence report and changes the business intelligence report based on the analysis of the parameters and parameter values in the news article associated with the uniform resource locator dragged and dropped on the business intelligence report. Parameters are business intelligence attributes where any characteristic can be assigned. In this example, the parameters may be Country, Year, Currency, Auto Product Name, and the like. The parameter values may be, for example, auto product name A1, auto product name B2, auto product name C3, and auto product name D4, which the business intelligence report manager identified in the news article during the analysis.

After identifying the parameter values in the new article, the business intelligence report manager applies the parameter values to the currently open business intelligence report. As a result, the currently open business intelligence report now only shows that the sales for auto product name A1, auto product name B2, auto product name C3, and auto product name D4 across the world for that particular year are down in the United States, Germany, France, Switzerland, Italy, United Kingdom, and Australia by a sales value of 5,000, 2,000, 3,000, 3,000, 4,000, 2,000, and 5,000, respectively. Thus, the business intelligence report manager automatically adjusts the currently open business intelligence report based on relevant content of the news article associated with the uniform resource locator dragged and dropped on the currently open business intelligence report.

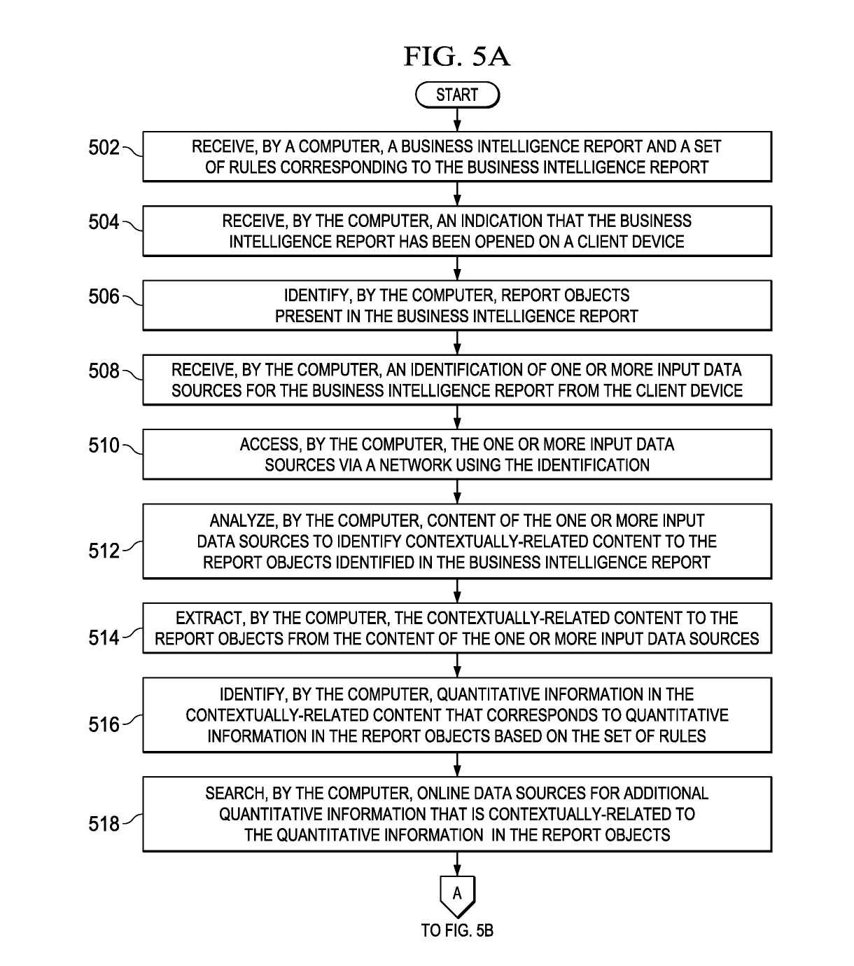

With reference now to FIGS. 5A-5B, a flowchart illustrating a process for contextual analysis of a business intelligence report is shown in accordance with an illustrative embodiment. The process shown in FIGS. 5A-5B may be implemented in a computer, such as, for example, server 104 in FIG. 1 or data processing system 200 in FIG. 2.

The process begins when the computer receives a business intelligence report and a set of rules corresponding to the business intelligence report (step 502). Subsequently, the computer receives an indication that the business intelligence report has been opened on a client device (step 504). The computer identifies report objects present in the business intelligence report (step 506).

In addition, the computer receives an identification of one or more input data sources for the business intelligence report from the client device (step 508). Further, the computer accesses the one or more input data sources via a network using the identification (step 510). Furthermore, the computer analyzes content of the one or more input data sources to identify contextually-related content to the report objects identified in the business intelligence report (step 512).

The computer extracts the contextually-related content to the report objects from the content of the one or more input data sources (step 514). Moreover, the computer identifies quantitative information in the contextually-related content that corresponds to quantitative information in the report objects based on the set of rules (step 516). The computer also searches online data sources for additional quantitative information that is contextually-related to the quantitative information in the report objects (step 518).

Afterward, the computer calculates a degree of impact the quantitative information from the one or more input data sources and the additional quantitative information from the online data sources has on the quantitative information in the report objects of the business intelligence report based on the set of rules (step 520). In addition, the computer replaces the quantitative information in the report objects of the business intelligence report with the quantitative information from the one or more input data sources (step 522). The computer also adds the additional quantitative information from the online data sources to the business intelligence report (step 524).

Then, the computer recalculates the business intelligence report using the quantitative information from the one or more input data sources and the additional quantitative information from the online data sources (step 526). Afterward, the computer displays the recalculated business intelligence report showing the degree of impact of the quantitative information from the one or more input data sources and the additional quantitative information from the online data sources on the client device (step 528). Thereafter, the process terminates.

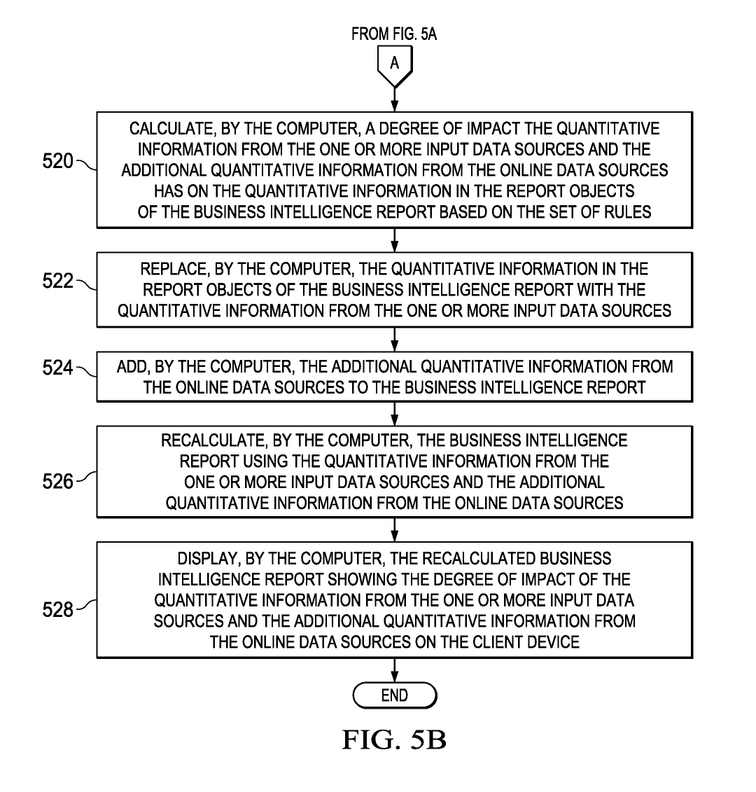

With reference now to FIG. 6, a flowchart illustrating a process for adjusting a business intelligence report is shown in accordance with an illustrative embodiment. The process shown in FIG. 6 may be implemented in a computer, such as, for example, server 104 in FIG. 1 or data processing system 200 in FIG. 2.

The process begins when the computer receives a uniform resource locator of a web document corresponding to content of a business intelligence report (step 602). The computer extracts an unstructured text stream from the web document (step 604). In addition, the computer identifies a set of parameter values that are contextually-related to the content of the business intelligence report (step 606). Further, the computer adjusts the business intelligence report using the set of parameter values that are contextually-related to the content of the business intelligence report (step 608). Thereafter, the process terminates.

Thus, illustrative embodiments of the present invention provide a computer-implemented method, computer system, and computer program product for adjusting a business intelligence report using information contextually-related to content of the business intelligence report extracted from one or more input data sources. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for adjusting a business intelligence report, the computer-implemented method comprising:
receiving, by a computer, an identification of an input data source corresponding to content of the business intelligence report from a client device via a network;
extracting, by the computer, an unstructured text stream from the input data source;
identifying, by the computer, a set of parameter values that are contextually-related to the content of the business intelligence report; and
adjusting, by the computer, the business intelligence report using the set of parameter values that are contextually-related to the content of the business intelligence report.

2. The computer-implemented method of claim 1 further comprising:
receiving, by the computer, an indication that the business intelligence report is open on a display of the client device; and
identifying, by the computer, report objects present in the business intelligence report.

3. The computer-implemented method of claim 1 further comprising:
accessing, by the computer, the input data source via the network using the identification.

4. The computer-implemented method of claim 1 further comprising:
analyzing, by the computer, content of the input data source using natural language processing to identify contextually-related content to report objects identified in the business intelligence report; and
extracting, by the computer, the contextually-related content to the report objects from the content of the input data source.

5. The computer-implemented method of claim 1 further comprising:
identifying, by the computer, quantitative information in contextually-related content that corresponds to quantitative information in the business intelligence report based on a set of rules.

6. The computer-implemented method of claim 1 further comprising:
searching, by the computer, online data sources for additional quantitative information that is contextually-related to quantitative information in the business intelligence report.

7. The computer-implemented method of claim 6 further comprising:
adding, by the computer, the additional quantitative information from the online data sources to the business intelligence report.

8. The computer-implemented method of claim 1 further comprising:
calculating, by the computer, a degree of impact quantitative information from the input data source and additional quantitative information from an online data source have on quantitative information in the business intelligence report based on a set of rules.

9. The computer-implemented method of claim 8 further comprising:
recalculating, by the computer, the business intelligence report using quantitative information from the input data source and the additional quantitative information from the online data source.

10. The computer-implemented method of claim 9 further comprising:
displaying, by the computer, the recalculated business intelligence report showing the degree of impact of the quantitative information from the input data source and the additional quantitative information from the online data source on the client device.

11. The computer-implemented method of claim 1, wherein the identification of the input data source is a uniform resource locator of a web document.

12. The computer-implemented method of claim 11, wherein a user of the client device drags and drops the uniform resource locator of the web document in the business intelligence report displayed on the client device.

13. The computer-implemented method of claim 1, wherein the computer adjusts the business intelligence report in real time based on current up-to-the-minute data available in streaming media sources.

14. A computer system for adjusting a business intelligence report, the computer system comprising:
a bus system;
a storage device connected to the bus system, wherein the storage device stores program instructions; and
a processor connected to the bus system, wherein the processor executes the program instructions to:
receive an identification of an input data source corresponding to content of the business intelligence report from a client device via a network;
extract an unstructured text stream from the input data source;
identify a set of parameter values that are contextually-related to the content of the business intelligence report; and
adjust the business intelligence report using the set of parameter values that are contextually-related to the content of the business intelligence report.

15. A computer program product for adjusting a business intelligence report, the computer program product comprising a computer readable storage medium having program instructions embodied therewith, the program instructions executable by a computer to cause the computer to perform a method comprising:
receiving, by the computer, an identification of an input data source corresponding to content of the business intelligence report from a client device via a network;
extracting, by the computer, an unstructured text stream from the input data source;
identifying, by the computer, a set of parameter values that are contextually-related to the content of the business intelligence report; and
adjusting, by the computer, the business intelligence report using the set of parameter values that are contextually-related to the content of the business intelligence report.

16. The computer program product of claim 15 further comprising:
receiving, by the computer, an indication that the business intelligence report is open on a display of the client device; and
identifying, by the computer, report objects present in the business intelligence report.

17. The computer program product of claim 15 further comprising:
accessing, by the computer, the input data source via the network using the identification.

18. The computer program product of claim 15 further comprising:
analyzing, by the computer, content of the input data source using natural language processing to identify contextually-related content to report objects identified in the business intelligence report; and
extracting, by the computer, the contextually-related content to the report objects from the content of the input data source.

19. The computer program product of claim 15 further comprising:
identifying, by the computer, quantitative information in contextually-related content that corresponds to quantitative information in the business intelligence report based on a set of rules.

20. The computer program product of claim 15 further comprising:
searching, by the computer, online data sources for additional quantitative information that is contextually-related to quantitative information in the business intelligence report.
